(19) United States
(12) Patent Application Publication
(10) Pub. No.: US 2014/0223290 A1
(43) Pub. Date: Aug. 7, 2014

(54) Creating a transposed document defined by transposed markup language including transposed text

(71) Applicant: QUALCOMM INCORPORATED, San Diego, CA (US)

(72) Inventor: Robert A. HATHAWAY, San Diego, CA (US)

(73) Assignee: QUALCOMM Incorporated, San Diego, CA (US)

(21) Appl. No.: 13/757,457

(22) Filed: Feb. 1, 2013

(51) Int. Cl. G06F 17/21

(52) U.S. Cl. CPC G06F 17/218
USPC 715/235; 715/234

(57) ABSTRACT

Disclosed is an apparatus, system, and method to provide a document to an external user in which the markup language to create the document is transposed such that the text of the markup language is very difficult to copy. A document may be received by a computing device that is defined by a standard markup language including the text of the document. The document may be transposed by the computing device by alternative glyphs to create a transposed document that is defined by a transposed markup language including transposed text. The transposed document may be accessed by the user.

### BACKGROUND

1. Field

The present invention relates to an apparatus, system, and method to provide a document to an external user in which the markup language to create the document is transposed.

2. Relevant Background

In order to protect documents that are made available to external users from a server, while at the same time producing user-friendly documents, documents are often watermarked and/or obfuscated by other means to protect the documents. These documents are typically created in standard markup language (e.g., hyper text markup language (HTML)) that also includes the text of the document. In this way, an external user can look at it through a browser on a computer that accesses the server.

Although some methods are presently used to attempt to secure the document from copying, such as, by inter-leaving proprietary notices or copyright notices or adding a graphic watermark within the HTML, these methods are typically very easy to circumvent.

Unfortunately, presently, standard markup language itself, such as HTML, can be easily copied by external customers including the text, such that documents are not provided in a secure manner.

### SUMMARY

Aspects of the invention may relate to an apparatus, system, and method to provide a document to an external user in which the markup language to create the document is transposed. A document may be received by a computing device that is defined by a standard markup language including the text of the document. The document may be transposed by the computing device by alternative glyphs to create a transposed document that is defined by a transposed markup language including transposed text. The transposed document may be made accessible by the user.

### BRIEF DESCRIPTION OF THE DRAWINGS

FIG. 1 is a diagram of a system in which aspects of the invention related to providing a document to an external user in which the markup language to create the document is transposed may be practiced.

FIG. 2 is a flow diagram illustrating a process to transpose a document by alternative glyphs.

FIG. 3 is a diagram illustrating examples of normal characters and alternative glyphs.

FIG. 4A is a diagram illustrating an example of the display of a document.

FIG. 4B is a diagram illustrating an example of transposed markup language for the document.

### DETAILED DESCRIPTION

The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

Embodiments of the invention relate to a method, apparatus, and system to provide a document to an external user utilizing a browser in which the markup language to create the document is transposed such that the text of the document (in the markup language) is very difficult to copy.

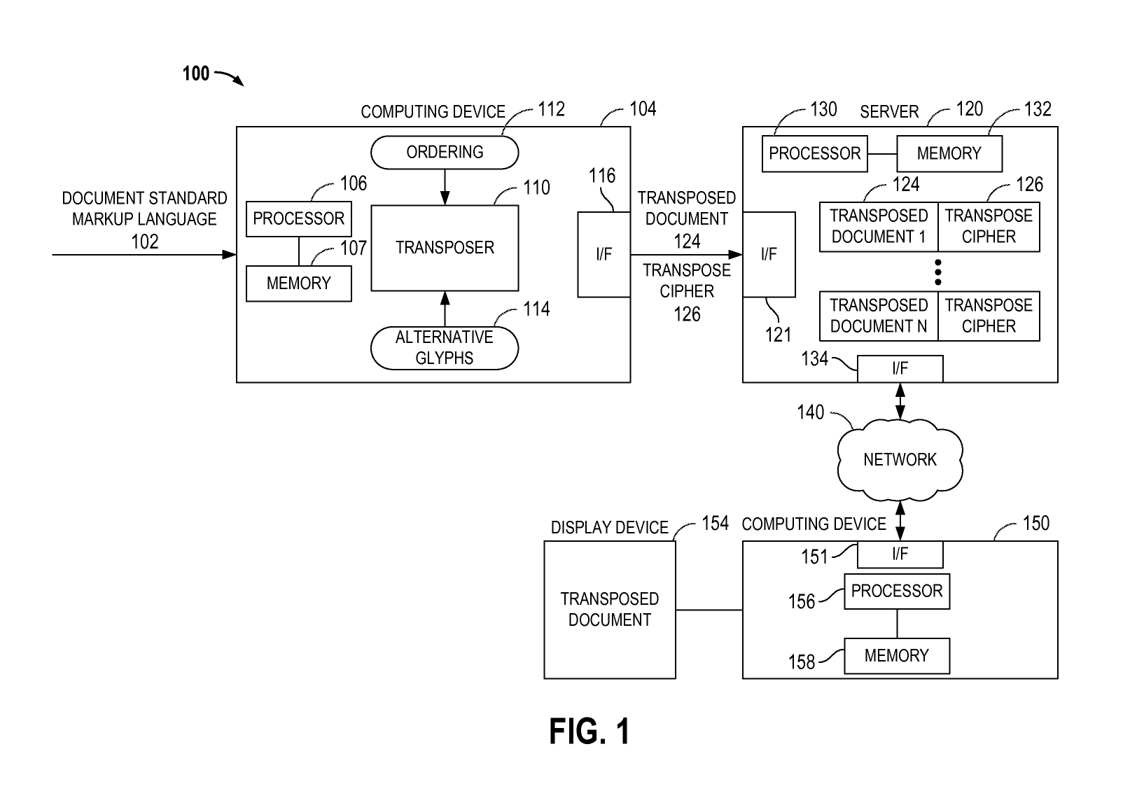

With reference to FIG. 1, in one embodiment, a method is implemented in which a computing device 104 receives a document 102 that is defined by standard markup language including text. As a particular example, computing device 104 may include a processor 106 configured to execute operations to be hereinafter described. Memory 107 may store operations, applications, programs, routines, etc., to aid in implementing these operations and functions.

In particular, computing device 104 may implement functions under the control of processor 106: to receive a document 102 that is defined by standard markup language (e.g., hypertext markup language (HTML)) including text and to implement a transposer 110 that may transpose the standard document by utilizing alternative glyphs 114 to create a transposed document 124 that is defined by transposed markup language including transposed text. In particular, the transposed document 124 may be created by substituting the characters of the standard markup language including the text of the received document 102 with alternative glyphs 114 to create the transposed document 124. Thus, the transposed document 124 is defined by transposed markup language and transposed text that includes alternative glyphs 114. The transposed document 124 and a corresponding transpose cipher 126 may then be transmitted through an interface (UF) 116 to a server 120 through the server's corresponding OF 121.

As will be described, a user operating a computing device 150 may then access the transposed document 124 from the server 120. The transpose cipher 126 correlated to the transposed document 124 operates as a cipher to decipher the transposed text to allow the server 120 to provide the text of the original document to the user for display—but if a user looks at the HTML language defining the transposed document 124 only the alternative glyphs 114 of the transposed markup language and transposed text appears. Thus, the text included in the HTML language is very difficult to copy because both the markup language and the text have been replaced with unintelligible glyphs.

Further, in one embodiment, in creating the transposed document 124, the substituting of the characters of the standard markup language and the text of the received document 102 with alternative glyphs 114 may be performed in a pre-defined ordering 112 format of alternative glyphs to characters from the received document 102. In one example, this pre-defined ordering 112 may be a random ordering of the alternative glyphs to characters from the received document 102. It should be appreciated that a glyph may be defined as a graphic symbol that provides the appearance of a character. Additionally, alternative glyphs that are used may also utilize alternative fonts.

Computing device 104 may be any sort of wired or wireless computing device in communication with server 120. Thus, I/Fs 116 and 121 may be any suitable type of wired or wireless interface. Further, in one embodiment, computing device 112 may be part of server 120 and not a separate computing device, such that all of the functionality of computing device 112 may be implemented in server 120. Computing device 104 and server 120 may be any type of computing devices, such as: personal computers, desktop computers, laptop computers, mobile computers, mobile devices, wireless devices, wireless phones, cell phones, smart phones, tablets, or any type of mobile or non-mobile computing device. Like computing device 104, server 102 may include a processor 130 configured to execute operations to be hereinafter described and a memory 132 to store operations, applications, programs, routines, etc., to aid in implementing these operations and functions. Further, server 120 may include a wired or wireless I/F 134 such that a user operating a computing device 150 may connect to server 120 through its wired or wireless I/F 151 through a network 140 and may view the transposed document 124 by accessing the server.

As can be seen in FIG. 1, in one embodiment, server 120 may store transposed documents 1-N 124 and corresponding transposed ciphers 126 received from computing device 104. In particular, server 120 may store the transposed documents 124 and corresponding transposed ciphers 126 to interact via interfaces 134 and 151 through a (wired or wireless network) 140 with a computing device 150 of a user.

Thus, received documents 102 defined by standard markup language including text may be transposed by transposer 110 and transmitted to server 120. Each document 102 may be transposed by substituting the characters of the standard markup language and the text of the standard markup language with alternative glyphs to create the transposed document 124. Server 120 may then store each transposed document 1-N 124 which is defined by transposed markup language including transposed text. Associated with each transposed document 124 is a transposed cipher 126 that may be used to decipher the transposed text such that a viewer may view the original text. In this way, when a user at a computing device 150 accesses a transposed document 124, the user at computing device 150 is shown the transposed document on their display 154 as a normal document with the original text. The transposed cipher 126 correlated to the transposed document 124 operates as a cipher to allow the server 120 to provide the text of the original document to the user as the transposed document—but if a user looks at the HTML language defining the transposed document 124 only the alternative glyphs of the transposed markup language including the text appears. Thus, the text included in the HTML language is very difficult to copy because both the markup language and the text have been replaced with unintelligible glyphs. In fact, if a user attempts to copy the transposed markup language and transposed text this results in only copying the alternative glyphs which is meaningless.

It should be appreciated that computing device 150 may be any type of computing device, such as a: personal computer, desktop computer, laptop computer, mobile computer, mobile device, wireless device, wireless phone, cell phone, smart phone, tablet, or any type of mobile or non-mobile computing device. Computing device 150 may include a processor 156 configured to execute operations to be hereinafter described and a memory 158 to store operations, applications, programs, routines, etc., to aid in implementing these operations and functions.

As an example, upon a request from a user at a computing device 150, the transposed document 124 may be deciphered and transmitted to the user from server 120 such that the user can view the transposed document on their display device 154 which appears as the original document. However, if the user attempts to copy the transposed markup language and transposed text contained therein (e.g., the HTML language), the user is only coping the alternative glyphs.

In one embodiment, the transposed document that is defined by the transposed markup language may include both markup language commands and text that are transposed with alternative glyphs. For example, in HTML markup language, both the commands, such as HTML elements including tags and attributes, as well as the text between the start tag and end tag, may be transposed with alternative glyphs. In another embodiment, only the text is transposed with alternative glyphs and not the commands. For example, in HTML markup language, the HTML elements including the tags will not be transposed with alternative glyphs (remaining as standard tags) but the text contained within the tags may be transposed with alternative glyphs. Also, in an additional embodiment, as an example, in order to further obfuscate the HTML markup language elements (e.g., tags), Unicode or extended characters may be used in tag names (not utilizing alternative glyphs) which are defined in a CSS. In this example, certain HTML tags can be changed to other newly defined tags. As a particular example, tags <p> . . . </p> could be changed <foi> . . . </foi> and this new tag could be defined in the CSS. This would obfuscate the HTML tags to anyone viewing the HTML source. It should be appreciated that these are merely examples of techniques to obfuscate markup language commands and text and that a wide variety of different techniques are illustrated herein. Further, although HTML is provided as an example of a markup language, a wide variety of different types of markup languages may implement aspects of the invention.

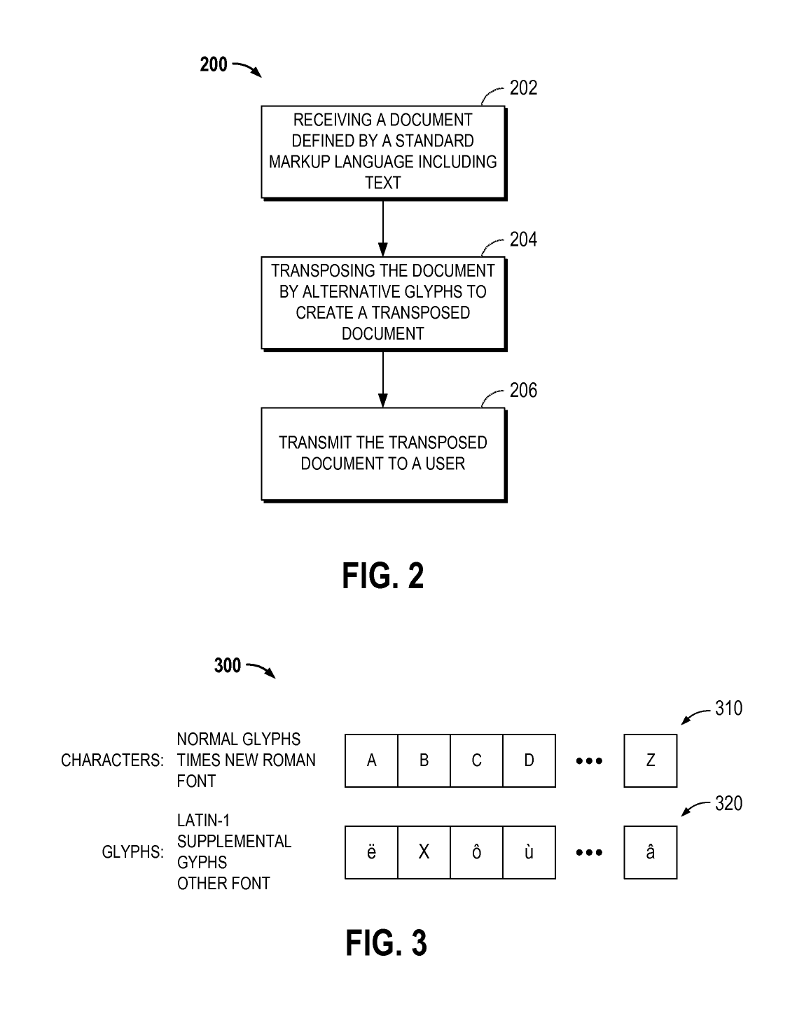

With brief reference to FIG. 2, embodiments of the invention relate to a process 200 to generate a transposed document that is transmitted to a user. For example, at block 202, a document may be received by a computing device 104 that is defined by a standard markup language including text. Next, the document is transposed by alternate glyphs to create a transposed document that is defined by a transposed markup language including transposed text. The transposed document may be stored at a server 102 from which it may be transmitted to a user (block 206).

With additional reference to FIG. 3, a document utilizing standard markup language (e.g., document 102) may include text utilizing normal characters 310 utilizing normal glyphs and a normal font (e.g., Times New Roman); A, B, C, D . . . Z. However, as previously described, these normal characters may be transposed to use another font with other unintelligible pre-defined glyphs 320 (e.g., Latin-1 Supplemental): (ë, ñ, õ, ú . . . â). Further, cascading style sheet (CSS) language may be utilized in combination with HTML language to provide further security schemes. As an example further security may be accomplished by referencing glyphs/fonts within the CSS language which itself is referenced from the HTML.

Thus, embodiments of the invention may relate to generating a transpose cipher 126 utilizing a transposer 110 in which alternative glyphs 114 (as well as differing ordering and alternative fonts) supported by CSS are used to obfuscate original markup language (HTML) into a transposed document 124 that includes transposed markup language and transposed text therein. The transposed document 124 in association with the transposed cipher 126 may be stored at server 120 such that a user at a computing device 150 can view the transposed document 154 on a display device which appears perfectly normal to the user based upon deciphering by the transpose cipher 126. However, if the user attempts to copy the text by attempting to access the HTML language, this is very difficult because both the markup language and the text have been transposed by the transposed cipher 126 such that all of the glyphs of the original markup language and text have been replaced by unintelligible glyphs.

As an example, a user at computing device 150 may download a transposed document 124 from server 120. The document is displayed on their display device 154 as with the regular text of the document because it is deciphered by the transposed cipher 126 such that it appears normally to the user. However, the actual hypertext markup language (HTML) that can be viewed and copied by the user is actually transposed by the transpose cipher 126 (unknown to the user) such that all of the accessible markup language (and text of the document contained therein) is all unintelligible glyphs. Thus, the transposed document 124 is very difficult to copy because both the markup language and the text within the original markup language have been transposed such that all the characters of the original HTML markup language and the text therein have been replaced with unintelligible glyphs.

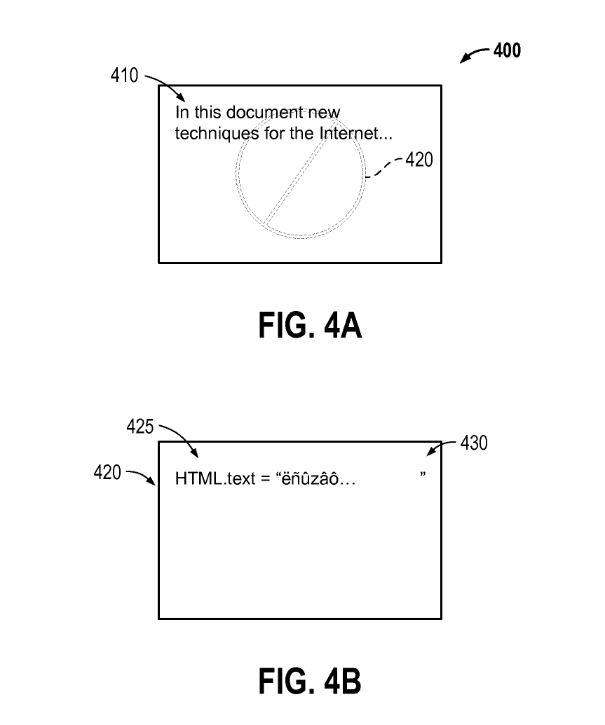

With additional reference to FIGS. 4A and 4B, an example will be illustrated. For example, assuming the original document 102 utilizing standard markup language (HTML) includes the text: “In this document new techniques for the Internet . . . ” along with a watermark, this document converted to transposed document 124, when accessed by a user at computing device 150 will still appear on their display device 154 as shown in screen 400 of FIG. 4A with the same text 410 (via conversion by the transpose cipher 126 at the server 120) and the same watermark 420.

As previously described, original document 102 utilizing standard markup language (HTML) may be transposed by computing device 104 implementing a transposer 110 to transpose the document with alternative glyphs 114 in order to create a transposed document 124 defined by a transposed markup language including transposed text. For example, in creating the transposed document 124 utilizing transposer 110 an altered file is prepared in which characters from the normal ASCII range of characters are copied over by glyphs of seldom-used characters (e.g., the Latin-1 Supplement Range, UTF-8 0x0080 thru 0x00FF)), thus, transposer 110 transposes the original document 102 by alternative glyphs by substituting the characters of the standard markup language that includes the text of the received document with alternative glyphs to create the transposed document 124. For added security, these glyphs may be substituted out-of-order by an ordering function 112. In this way, the characters of the normal HTML content may be transposed to create the transpose document 124 that is defined by transposed markup language including the transposed text of the document such as by alternative glyphs in the Latin-1 Supplemental Range.

As an example, with additional reference to FIG. 4B, if a user attempts to look at the HTML markup language 420 on their display device and in particular the text 425 of the HTML markup language, all of this appears as transposed markup language and transposed text 425 that has been changed to utilize altered glyphs 430 such that access to the markup language only provides transposed markup language and transposed text to the user which is completely unintelligible to the user.

In this way, the original document 102 now shown as 400 includes the original text 410 and a watermark 420 that is visible to the user of computing device 150 on their display device 154 by accessing the server. However, if the user attempts to copy and paste the text of the transposed HTML markup language 425 they may only copy and paste transposed text that includes unintelligible glyphs. In this example, the markup language may include text utilizing standard characters/fonts: A B C D . . . Z . . . a, b, c, d, . . . z that is transposed to using other unintelligible glyphs/fonts (e.g. Latin-1 Supplemental): ëñúzâõ . . . .

Thus, although a user may still be able to make a graphics-based copy of the text 410, this leaves the user making such a copy without an original text-based document including the watermark 420 in addition to any other sort of copyright or proprietary designations. On the other hand, if the user attempts to cut and copy text from the HTML itself, this is very difficult because the HTML markup language including the text has been transposed with unintelligible pre-defined glyphs. For example, the glyphs 430 of FIG. 4B.

Further, embodiments of the invention may be combined with other features such as: interleaving paragraphs, copyright statements, proprietary statements, graphic watermarks, etc. All of these may be done via CSS alterations. Additionally, server 120 may be a secure server adding more security in making attempts to defeat the methodology more difficult to read.

It should be appreciated that aspects of the invention previously described may be implemented in conjunction with the execution of instructions by processors of the devices, as previously described. Particularly, circuitry of the devices, including but not limited to processors, may operate under the control of a program, routine, or the execution of instructions to execute methods or processes in accordance with embodiments of the invention. For example, such a program may be implemented in firmware or software (e.g. stored in memory and/or other locations) and may be implemented by processors and/or other circuitry of the devices and the server. Further, it should be appreciated that the terms processor, microprocessor, circuitry, controller, etc., refer to any type of logic or circuitry capable of executing logic, commands, instructions, software, firmware, functionality, etc.

It should be appreciated that when the devices are mobile or wireless devices that they may communicate via one or more wireless communication links through a wireless network that are based on or otherwise support any suitable wireless communication technology. For example, in some aspects the wireless device and the other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The techniques described herein can be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers Interim Standard (IS)-2000, IS-95 and IS-856 standards. A TDMA system can implement a radio technology such as Global System for Mobile Communications (GSM). An OFDMA system can implement a radio technology such as Evolved Universal Terrestrial Radio Access; (Evolved UTRA or E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDM®, etc. Universal Terrestrial Radio Access (UTRA) and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, an entertainment device, a set-top box, or any other suitable device. These devices may have different power and data requirements

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method comprising:
receiving a document that is defined by a standard markup language including text;
transposing the document by alternative glyphs to create a transposed document that is defined by a transposed markup language including transposed text; and
allowing a user to access the transposed document.

2. The method of claim 1, wherein transposing the document by alternative glyphs further comprises substituting the characters of the standard markup language and the text of the received document with alternative glyphs to create the transposed document.

3. The method of claim 2, wherein the transposed document includes transposed markup language and transposed text having the alternative glyphs.

4. The method of claim 2, wherein the alternative glyphs are from an alternative font.

5. The method of claim 2, wherein substituting the characters of the standard markup language and the text of the received document with alternative glyphs is performed in a pre-defined ordering of alternative glyphs to characters from the received document.

6. The method of claim 2, wherein substituting the characters of the standard markup language and the text of the received document with alternative glyphs is performed based upon a random ordering of alternative glyphs to characters from the received document.

7. The method of claim 1, wherein the transposed document is accessible by the user from a server such that the user can view the transposed document by accessing the server.

8. The method of claim 7, wherein attempting to copy the transposed markup language and transposed text results in only copying the alternative glyphs.

9. The method of claim 1, wherein the standard markup language is a hyper text markup language (HTML).

10. The method of claim 9, further comprising utilizing cascading style sheet (CSS) language in combination with HTML.

11. A computing device comprising:
an interface; and
a processor to execute operations including:
receiving a document that is defined by a standard markup language including text; and
transposing the document by alternative glyphs to create a transposed document that is defined by a transposed markup language including transposed text.

12. The computing device of claim 11, wherein transposing the document by alternative glyphs further comprises substituting the characters of the standard markup language and the text of the received document with alternative glyphs to create the transposed document.

13. The computing device of claim 12, wherein the transposed document includes transposed markup language and transposed text having the alternative glyphs.

14. The computing device of claim 12, wherein the alternative glyphs are from an alternative font.

15. The computing device of claim 12, wherein substituting the characters of the standard markup language and the text of the received document with alternative glyphs is performed in a pre-defined ordering of alternative glyphs to characters from the received document.

16. The computing device of claim 12, wherein substituting the characters of the standard markup language and the text of the received document with alternative glyphs is performed based upon a random ordering of alternative glyphs to characters from the received document.

17. The computing device of claim 11, wherein the transposed document is transmitted to a server such that a user can view the transposed document by accessing the server.

18. The computing device of claim 17, wherein the computing device is included in the server.

19. The computing device of claim 17, wherein attempting to copy the transposed markup language and transposed text results in only copying alternative glyphs.

20. The computing device of claim 11, wherein the standard markup language is a hyper text markup language (HTML).

21. The computing device of claim 20, further comprising utilizing cascading style sheet (CSS) language in combination with HTML.

22. A computing device comprising:
means for receiving a document that is defined by a standard markup language including text;
means for transposing the document by alternative glyphs to create a transposed document that is defined by a transposed markup language including transposed text; and
means for allowing access to the transposed document by a user.

23. The computing device of claim 22, wherein transposing the document by alternative glyphs further comprises means for substituting the characters of the standard markup language and the text of the received document with alternative glyphs to create the transposed document.

24. The computing device of claim 23, wherein the transposed document includes transposed markup language and transposed text having the alternative glyphs.

25. The computing device of claim 23, wherein the alternative glyphs are from an alternative font.

26. The computing device of claim 23, wherein substituting the characters of the standard markup language and the text of the received document with alternative glyphs is performed in a pre-defined ordering of alternative glyphs to characters from the received document.

27. The computing device of claim 23, wherein substituting the characters of the standard markup language and the text of the received document with alternative glyphs is performed based upon a random ordering of alternative glyphs to characters from the received document.

28. The computing device of claim 22, wherein attempting to copy the transposed markup language and transposed text results in only copying the alternative glyphs.

29. The computing device of claim 22, wherein the standard markup language is a hyper text markup language (HTML).

30. The computing device of claim 22, further comprising utilizing cascading style sheet (CSS) language in combination with HTML.

31. A computer program product executed at a computing device comprising:
a computer-readable medium comprising code for:
receiving a document that is defined by a standard markup language including text; and
transposing the document by alternative glyphs to create a transposed document that is defined by a transposed markup language including transposed text.

32. The computer program product of claim 31, wherein transposing the document by alternative glyphs further comprises code for substituting the characters of the standard markup language and the text of the received document with alternative glyphs to create the transposed document.

33. The computer program product of claim 32, wherein the transposed document includes transposed markup language and transposed text having the alternative glyphs.

34. The computer program product of claim 32, wherein the alternative glyphs are from an alternative font.

35. The computer program product of claim 32, wherein substituting the characters of the standard markup language and the text of the received document with alternative glyphs is performed in a pre-defined ordering of alternative glyphs to characters from the received document.

36. The computer program product of claim 32, wherein substituting the characters of the standard markup language and the text of the received document with alternative glyphs is performed based upon a random ordering of alternative glyphs to characters from the received document.

37. The computer program product of claim 32, further comprising code for transmitting the transposed document to a server such that a user can view the transposed document by accessing the server.

38. The computer program product of claim 37, wherein attempting to copy the transposed markup language and transposed text results in only copying the alternative glyphs.

39. The computer program product of claim 31, wherein the standard markup language is a hyper text markup language (HTML).

40. The computer program product of claim 39, further comprising coder for utilizing cascading style sheet (CSS) language in combination with HTML.
